(19) United States
(12) Patent Application Publication
(10) Pub. No.: US 2026/0221347 A1
(43) Pub. Date: Jul. 30, 2026

(54) ELECTRODE, CAPACITIVE ELEMENT, CAPACITOR, PRECURSOR MATERIAL

(71) Applicant: TDK Electronics AG, Muenchen (DE)

(72) Inventors: László Dobai, Szeleste (HU); Gloria Gerardini, Siziano (IT)

(21) Appl. No.: 19/462,460

(22) Filed: Jan. 28, 2026

(30) Foreign Application Priority Data
Jan. 29, 2025 (DE) 102025103206.8

(51) Int. Cl. H01G 9/045; H01G 9/00; H01G 9/052

(52) U.S. Cl. CPC H01G 9/045; H01G 9/0029; H01G 9/052

(57) ABSTRACT

In an embodiment an electrode includes a sintered portion having merged or sintered particles, wherein the particles include a valve metal or a metal from the boron group, and wherein the sintered portion and/or the particles include an oxide portion that includes phosphorus.

### CROSS-REFERENCE TO RELATED APPLICATIONS

This application claims priority of German Patent Application No. 102025103206.8, filed on Jan. 29, 2025, which application is hereby incorporated herein by reference.

### TECHNICAL FIELD

The present application concerns an electrode, a capacitive element, a capacitor, a precursor material, a process of producing a precursor material and a process of producing an electrode.

### BACKGROUND

Improving capacitors in general, and electrolytic capacitors in particular, can present several challenges.

### SUMMARY

Embodiments provide an improved volume efficiency per volume for a capacitor.

Embodiments provide an electrode that has a sintered portion and provide capacitors of high volume efficiency. A sintered portion can comprise or consist of merged or sintered particles. “Merged” means here that particles in the sintered portion are not loose but are incorporated in a solid and preferably porous structure of particles that are partly fused together with other particles. The particles may form a network. Such a sintered portion of merged particles can be achieved in general by any means. In particular, it may be achieved by sintering of particles, i.e. by a heating or annealing step that merges or fuses the particles. This means that the term “sintered portion” is not limited to a portion or body of particles that have actually been sintered. Any other technique leading to a similar merging of particles can form a sintered portion despite, for example, no heat treatment being applied. However, sintering is the most preferred technique.

According to an embodiment, the particles comprise a valve metal or a metal from the boron group. This may include, for example, that the particles can comprise an alloy including a valve metal or a metal from the boron group. According to an embodiment the particles may also comprise two or more metals from the group consisting of valve metals and metals from the boron group. Also, according to an embodiment different particles comprising or consisting of different materials can be present in a sintered portion. According to an embodiment, all particles in a sintered body have the same composition.

According to an embodiment, the sintered body can be arranged on a substrate. The substrate, for example, may be a foil substrate. In such a case, the sintered portion can form a layer on a surface of the foil. According to an embodiment each side of a substrate foil can carry a sintered portion. According to an embodiment, the substrate also comprises or consists of a valve metal or a metal from the boron group. The composition of the substrate may differ from the composition of the particles. According to an embodiment, as a main component the substrate has the same valve metal or a metal from the boron group that forms a main component of the particles. The substrate and the particles may also comprise the same material.

According to an embodiment, an electrode having a foil substrate and at least one sintered portion can be addressed as a foil electrode. Such a foil electrode may, for example, be used as an anode of an electrolytic capacitor. According to an embodiment, the foil can have a thickness of 50 to 200 μm such as preferably of 70 to 180 μm. Generally, but preferably in case the foil has the beforementioned thickness, the sintered portion on the foil may have a thickness of 40 to 130 μm.

“Valve metal” is to be understood in the general technical sense and is not otherwise limited. For example, valve metal may mean and include at least aluminum, titanium, tantalum, niobium, tungsten, chromium, zirconium, hafnium, zinc, vanadium, bismuth or antimony. Of these, in particular aluminum, tantalum and vanadium are preferred. The most preferred valve metal used for electrodes for the embodiments disclosed herein is aluminum. The same holds true for “metals from the boron group”. In the broadest sense this includes all metals from group III of the periodic table except for boron, which is not considered as a metal. Again, the most important example, which also shows overlap with the group defined by “valve metals”, is aluminum.

The inventors have found that besides the great advantage of providing good volume efficiency, the use of sintered electrodes can present several challenges. The inventors found that there may be issues with parameters such as fragility, flexibility or leakage current. The latter is also often connected with fragility or flexibility. The inventors observed that more rigid foils tend to crack due to mechanical stress such as bending, local gas generation or micro sparks. This may lead to the formation of free aluminum surface which generates additional leakage current. Also, the applicable parameters during a so-called forming step may depend on the above properties. The forming step addresses chemical or, most relevantly, electrochemical formation of an oxide film on an electrode used in an electrolytic capacitor. During such a forming, the inventors observed that brittleness and fragility of a sintered electrode may even become worse. The inventors found that the oxide layer formed during the forming step can be even less flexible and more brittle than the substrate or the sintered particles before the forming step.

The issue of brittleness and low flexibility has been addressed so far by using low tension during winding of capacitor coils and low winding speeds. This may affect process speed and process costs. Nonetheless, usability of the foil may still be reduced, and the scrap rate may be high. Furthermore, small diameters are often not available in the production of winding elements because small radii were not possible for sintered foils.

Other potential disadvantages may become apparent from the explanations given below.

Accordingly, it is an aim of embodiments of the present invention to overcome at least some of the above-mentioned issues. In particular, several embodiments are provided below which at least partially improve or provide an alternative for one or more than one of the above-mentioned problems.

In the following, several embodiments of an electrode having a sintered portion are described. Each of the embodiments, if not explicitly mentioned otherwise, provides an individual advantage. However, there are several synergetic effects between the embodiments described below and the advantages may increase if the features of two or more embodiments are combined.

According to a first embodiment of the electrode, an average particle size of a size distribution of the particles is 6 μm or smaller. Embodiments provide comparatively small particle sizes of 6 μm or preferably below 6 μm that may help to increase the flexibility of an electrode having a sintered portion. Taken alone, but in particular when combined with other embodiments, this feature may help to produce a more bendable or more flexible electrode that is more resilient than an electrode with a larger average particle size.

“Average particle size of a size distribution” is understood as what is commonly understood by the term in the field. In particular it can mean the mathematical mean value in such a size distribution.

According to an embodiment, which in particular may be a modification of the above embodiment, the average particle size may be larger than 0.6 μm or preferably 1 μm or larger or more preferably it may be larger than 2 μm. The inventors found that if the particles become too small this may be disadvantageous. In particular, particles that are too small can be consumed during forming. This may be disadvantageous for conductivity, in particular for maintain continuous conductive paths in the formed electrode. Also, this may reduce the adhesion between the particles and between the particles and the surface of the substrate. For example, for aluminum particles that are small, such as for example 0.6 μm or smaller, there is increased risk, that the following may occur. When the forming liquid starts to oxidize a particle the following reaction or a similar reaction can take place: 4Al+3O₂→2Al₂O₃. If it is assumed that at for each volt of forming voltage around 1 to 1.3 nm of oxide are formed, and if for example a forming voltage of 500 V is applied this would mean for a particle size of 0.6 μm, the particle may become fully consumed and no metallic aluminum remains. This can be disadvantageous for maintaining continuous conductive paths. Also, if all metal is consumed there is increased risk of loosening between the particles and between the particles and the surface of the substrate.

Accordingly, according to an embodiment an average particle size of larger than 0.6 μm and smaller than or equal to 6 μm can be advantageous for the above-mentioned reasons. Even more preferably, a size range of 1 μm to 6 μm or larger than 1 μm to 6 μm, such as 2 μm to 6 μm is applied.

According to another embodiment, an average particle size can be such that a particle of this size is not fully transformed to an oxide in a forming step. The above-described considerations apply.

According to another embodiment, the sintered portion is formed from a mixture of at least a first group of particles and a second group of particles. Again, the sintered body is merged or sintered from the groups of particles. The first group of particles and the second group of particles both comprise a valve metal or a metal from the boron group. An average particle size of a size distribution of the first group of particles is smaller than that of the second group of particles.

The inventors found that having two different particle size distributions that average around different values can aid the capacity of the capacitor, but in particular it can also make the electrode more flexible. In particular, compared to a sintered portion that comprises only one size distribution of particles, the resulting electrode can be less rigid and more bendable. This can reduce the above-described disadvantages. In particular, the inventors found that the attachment of the sintered portion to a substrate can also be improved. The inventors assume that the differently sized particles adhere differently to the substrate, for example during a sintering step. The inventors found that this may improve adhesion. Also, the smaller particles tend to provide more surface area than the lager particles.

Also, when producing electrodes, sintered portions formed from different particle sizes can make the production flexible. In particular, according to an embodiment, after producing the sintered portion, an electrode can undergo a forming step, as described above, which preferably includes an anodic oxidative treatment in which an oxide layer is grown. The applied voltage is a key means for defining the thickness of the grown oxide. During oxidation, the valve metal present in the particles is converted to an oxide. Thus, having different size distributions allows at least some particles to always maintain metallic cores that can help with charge carrying. Accordingly, a premixture of at least two different size distributions may be used for different forming voltages.

According to a further embodiment, the average particle size of the first group of particles can be between 1 and 3 μm. According to an embodiment, the particle size of the second group of particles is larger than the first group. In particular, according to an embodiment, the average particle size of the second group of particles can be between 2.5 and 6 μm. Embodiments provide the above-mentioned advantages are particularly characteristic for having at least two different particle size distributions present in the sintered body that fall into the above ranges.

According to an embodiment a number ratio of the number of particles of the first group of particles to the second group of particles may be between 0.1 and 0.5 and preferably between 0.2 and 0.35.

Also, according to an embodiment a precursor particle composition is disclosed that comprises a first group of particles and a second group of particles. The properties discussed for the electrode may also apply to the precursor particle composition.

According to another embodiment that is advantageous, even individually, but which can also be combined with the other embodiments mentioned herein, the sintered portion and/or the particles in the sintered portion can be formed from or including particles that comprise a hydrated metal oxide. In particular, an oxide of the sintered portion or the particles formed in the sintered portion may be formed from or including the hydrated metal oxide. The particles used for producing the sintered portion in this case may be composite particles that have a metallic portion and a portion comprising a hydrated metal oxide. For example, these particles may be core shell particles which have a metallic portion and a hydrated metal oxide portion.

Embodiments provide particles with a hydrated metal oxide portion that can save energy in a forming step, i.e. during electrochemical formation of the oxide for example. Also, an electrode being formed from or including such particles with a hydrated metal oxide can be more flexible and less brittle. The inventors found that the hydrated metal oxide can be softer than bare metal particles or particles having a non-hydrated metal oxide. The inventors think that this helps to reduce sintering temperatures as the particles are merged more easily. Also the inventors think that this produces a denser and more flexible oxide before forming, but also after forming.

The inventors also observed that hydrated metal oxide particles can interact better with a binder in a slurry for producing a sintered portion. Binders, for example, can be polar polymers such as ethyl cellulose, PVDF or PVA or other similar polymers. These attach better and link better between particles with hydrated metal oxides than between pure metallic particles or particles which only have a natural oxide or a non-hydrated metal oxide. The inventors assume that this may also help in producing more flexible or less brittle electrodes.

In this context, according to an embodiment, a precursor material is described. The embodiments discussed in this context are not limited, However, the properties of the precursor material and of the process of producing a precursor material described below may also apply to the above-described embodiments addressing the electrode made including particles having a hydrated metal oxide portion and vice versa.

In the present case, the precursor material can be a material for producing a sintered portion of an electrode. The precursor material comprises particles that comprise a valve metal or a metal from the boron group as discussed above. The valve metal or a metal from the boron group can be addressed as M. The particles have a hydrated metal oxide portion. The particles can, in particular, be used to form the above-described electrode.

According to an embodiment, the particles can have a core shell structure having a metallic core that is at least partially covered or partially surrounded by the hydrated metal oxide portion as the shell of the particles. The core can have or consist of the metal M. The shell can consist of a hydrated metal oxide of the same metal M. Even more preferred, the core shell structure is fully developed in which a metal core is fully surrounded by a hydrated metal oxide. As stated above, this may help to produce a less rigid oxide and a better quality of the oxide and can reduce leakage currents and may also reduce the energy consumption of an electrochemical oxidation process.

According to a further embodiment of the precursor material, the metal M is aluminum. In this case, the hydrated metal oxide may be represented by Al₂O₃·xH₂O. According to an embodiment 1≤x≤2 applies for x. The above-mentioned advantages have been particularly observed in this range. In this context, it is even more preferred that for the value x the following applies: 1.0≤x≤2.0 or even 1.0<x<2.0. For example, the structure of the hydrated metal oxide can be boehmite or pseudoboehmite.

According to another embodiment of the precursor material, a thickness of the hydrated metal oxide portion can be higher than 4 nm. Alternatively, it can be higher than the thickness of a natural oxide on an aluminum-containing particle. A hydrated metal oxide that is thicker than this value can help to realize the above-defined advantages. In particular, according to an embodiment that is also preferable with regard to the advantages described above, the thickness can be equal to or higher than 50 nm. The inventors found that the above advantages are particularly apparent if a thickness of 50 nm or higher is realized for the hydrated metal oxide. It is particularly prevalent for the core shell structure of the particles. According to an embodiment, the thickness can be even higher. It can be 100 nm or higher, 250 nm or higher or even 500 nm or higher. These higher thicknesses can be advantageous for other embodiments. Generally, there is no limit for the upper end of the thickness of the hydrated metal oxide. However, according to an embodiment the thickness can be smaller than 1 μm or preferably smaller than or equal to 900 nm.

Furthermore, according to an embodiment a process of producing a precursor material is described. The advantages and properties of the precursor material as described above may apply. However, the process is not limited to these features.

According to a first embodiment, the process of producing a precursor material includes first providing metal particles that comprise or consist of a valve metal or a metal from the boron group. These metal particles are either purely metallic or alternatively have a natural oxide. Alternatively, they may also already have a portion of non-natural oxide that is not hydrated or is at least not as strongly hydrated as it is after the process has been performed. Furthermore, deionized water is provided. According to an embodiment, the deionized water is highly deionized and may be called “super pure deionized water”. For example, it may have a conductivity of 0.1 μS/cm or below. This conductivity is measured at 30° C. The metal particles are boiled in this water. Thereby, the hydrated metal oxide can be developed. In particular, the above-described formula for describing the hydrated metal oxide of Al₂O₃·xH₂O with 1≤x≤2 may apply.

According to an embodiment of the process of producing a precursor material, a content of silicon can be smaller than 0.5 mg/l. Here silicon can mean any compound comprising a silicon atom or ion. In particular, it may include water soluble silicon containing compounds. The inventors found that having no, or only such a trace amount, of silicon in the water is advantageous, as silicon can incorporate into the hydrated oxide and thereby into the later formed oxide of an electrode. Having silicon in the hydrated oxide or the oxide of the electrodes can have disadvantages.

According to an embodiment, the particles are boiled in the water for 2 to 60 minutes, such as for example between 2 and 30 min, or between 2 and 10 min, or for example between 2 and 5 min or between 3 and 10 min or between 3 and 5 min.

Further optional embodiments of the process can become apparent from other embodiments discussed below.

According to another embodiment of the electrode which may, at least in some cases, also apply to the precursor material for example, the sintered portion and/or particles that are part of or are comprised in the sintered portion can comprise an oxide portion. Said oxide portion may have any origin. For example, at least for certain embodiments it may originate from the hydrated metal oxide as described above. The oxide portion described for the present embodiment can comprise phosphorus. Embodiments provide several advantages for phosphorus being comprised in an oxide of an electrode. In particular, the inventors found that having some incorporation of phosphorus may help to reduce leakage current.

Phosphorus comprised in an oxide of any kind in the present application can mean the incorporation of any phosphorus compound in the oxide material of the oxide portion. The phosphorus-containing material here is not limited. Preferably the phosphorus-containing compound can have phosphor-oxide bonds. The phosphorus may also be connected at least to some oxygen atoms or ions in the oxide material. It can, for example, be referred to as a phosphate equivalent. In this context, a phosphate equivalent may be regarded as the value or amount of phosphate that results, or would result, when all of the phosphorus present in the oxide was in the form of phosphate. It is not required that the phosphorus is present as phosphate. For example, at least part of the phosphorus may be contained in the oxide in form of P₂O₃, which fits into the structure of the aluminum oxide (Al₂O₃). The behavior may be similar to a doping material.

According to an embodiment of the electrode, the phosphorus content may be as follows. Phosphorus, represented as a phosphate equivalent, is measured here relative to the macroscopic area of the electrode surface in the entire oxide portion. The resulting value can be 0.5 μmol×cm⁻² or higher. The inventors found that this value is particularly helpful in improving the long-term stability of the electrode and/or also in reducing the brittleness and/or leakage current. Even more preferably, and according to an embodiment, the content of phosphorus represented as phosphate equivalent is 0.8 μmol×cm⁻² or higher. These values may be regarded as average values which average over the entire amount of oxide material of said oxide portion.

The total amount of phosphorus can be measured by any suitable means. According to an embodiment, the following approach can be used. First, with the help of an accordingly sized punching tool, a cutout of an electrode having a sintered portion on two sides of a foil substrate is made. The punching tool produces two cuts, one of 31.25×mm 80 mm and a further separate piece of 7 mm×60 mm. Together the pieces have a macroscopic surface area of 29.2 cm² per side of the electrode.

The punched-out pieces are then weighted on analytical balance and the weight is recorded. The punched-out pieces are cut via scissors to roughly square shapes with sides of roughly 1 to 3 mm. The minimum weight of the square should be above 0.123 g, preferably it should be around 0.2 g. The cut pieces are then weighted again and subsequently placed into a 100 ml Erlenmeyer flask. 15 ml of distilled water is added to the cut sample and 8 mm of concentrated sulfuric acid is added. After covering the flask, for example by a watch glass, it is boiled on a heating plate that has 200 to 250° C. The boiling is continued until the entire foil is completely dissolved and a transparent solution is achieved.

When the solution is clear and after it is cooled to room temperature it is put into a 100 ml measuring cup. The pouring is carried out such that the residue left in the flask is also washed through. After that, the solution in the measuring cup is partly neutralized with 30 ml of 2 mol sodium hydroxide. Subsequently the vessel is filled to the mark with distilled water.

Subsequently, the phosphate content can be determined by any suitable means. For example, a colorimetric method using a test kit from Hach Lange LCK349 or an equivalent test kit, for example provided by Merck, may be used.

Alternatively, a UV/Vis spectrometer can be used. Therefore, before measuring the sample, a blank sample is measured which is formed from 1 ml of distilled water mixed with 4 ml of a phosphate reagent. The phosphate reagent has the following composition for a 21 volume of the reagent prepared in a measuring flask: 6.12 g of tartaric acid, 17.7 g of ammonium heptamolybdate and 0.46 g of ammonium monovanadate are mixed with 1l of water. Subsequently 108 ml of concentrated (65%) nitric acid is added, then the measuring flask is filled up to 21 with distilled water.

The absorbance value of the blank sample is subtracted from the absorbance value of the sample. For the actual sample, the above-described 100 ml solution comprising the dissolved electrode is stirred well or shaken well. 1 ml of the sample is pipetted into the cuvette of the spectrometer. Subsequently 4 ml of the above-described phosphate reagent are added. Both components are mixed well, for example by shaking. Additionally, a 5 minute waiting time is applied. After that, the cuvette is inserted into the UV/Vis spectrometer and the absorbance is read. The measurement is carried out in manual mode at 410 nm wavelength. The measured value is set to absorbance. The absolute amount of phosphate equivalent relative to the macroscopic surface area of the electrode can be calculated from these values.

According to another embodiment, a surface-near content of phosphorus in a surface-near region of the oxide portion can be higher than in non-surface-near portions of the oxide portion. A surface-near portion can be understood here as a microscopic surface-near portion. This may mean that the surface meant here is not the macroscopic surface of the electrode, but the microscopic surface formed from the sintered portion. In the case of the electrode being an electrode in an electrolytic capacitor, the surface can be the area wetted by the electrolyte.

According to an embodiment, the surface-near content of phosphorus represented as phosphate equivalent relative to the macroscopic area of the electrode is 10 mg·m⁻² or higher.

According to an embodiment, the surface-near region as described above can have a thickness of 5 to 10 nm.

The surface-near phosphorus can have the same advantage discussed above for phosphorus generally. In addition, the surface-near phosphorus may be particularly helpful in reducing hydration or sensitivity to water when the electrode is applied as an anode in an electrolyte capacitor. Previous sintered anodes sometimes have the disadvantage that even a small water content can lead to high leakage currents. Other types of adding phosphorus may also help in reducing the water sensitivity.

Generally, the process of measuring the surface-near content of phosphorus is not limited. However, according to an embodiment, it may be measured in the following way. First of all, a sample of 5 cm×10 cm, i.e. of 50 cm² is cut out from the electrode. This specimen is then cut into pieces of approximately 1 cm² (1 cm×1 cm). These pieces are placed into a glass beaker of a volume of 250 ml. Furthermore, 100 ml of deionized water is filled into the glass beaker. The pieces are boiled in the water for 10 min. Subsequently, the mixture of the pieces in the water is cooled to room temperature. After that, any boiled-off water is replaced by refilling the water volume back to 100 ml by adding additional deionized water. The mixture is shaken and/or stirred. Subsequently, the phosphate concentration is measured in the water in ppm. This can, for example, be carried out by a UV/Vis approach as described below or by using a colorimetric method using a test kit from Hach Lange LCK349. The test kit provides a value measured in ppm. This value has to be multiplied by 20 to get the value of the surface-near content of phosphorus in mg/m².

According to embodiments, further features of processes are described which apply to any of the above-described electrodes, including an electrode which has any type of sintered body which is not otherwise defined or described in the introduction.

According to an embodiment, in a process of producing an electrode first of all a slurry using particles comprising a valve metal or a metal from the boron group is formed. According to an embodiment of this process, the particles can be the above-described precursor particles or particles with above-described sizes or size distributions, but the process is not limited to the use of these particles. The slurry is applied to the surface of a substrate that may have the above-described properties. Furthermore, the slurry is heated at a first temperature and subsequently at a second temperature. The second temperature is higher than the first temperature.

According to embodiments, heating at two different temperatures can help to get a less stiff or rigid substrate which is less susceptible to becoming damaged when bent. This is particularly advantageous when using the above-described precursor material with the hydrated metal oxide. The inventors found that with this treatment it is possible at a first temperature to transform the hydrated metal oxide to a large degree into gamma aluminum oxide or an aluminum oxide of a similar structure. Also, the particles begin to link together at the lower first temperature. The higher second temperature fully sinters the particles and allows them to link together forming a sintered portion that also has a network of linked particles.

Also, the hydrated metal oxide is softer than a pure oxide. This allows this softer material to compact lightly at the first temperature, which is a mild heating, and subsequently link more strongly than if starting from a harder pure oxide.

According to an embodiment, the first temperature can be higher than 300° C. and lower than 470° C.

According to an embodiment, a maximum temperature used for annealing or sintering can be lower than 560° C. or even more preferably be 555° C. or below. In case of a two-step process this may apply to the second temperature, which can preferably be lower than 560° C. or even more preferably be 555° C. or below. Also, these temperatures may still be considered as mild heating.

The mild heating allows the electrode to become less rigid than if heated to temperatures above 560° C. In particular, by the two-step heating process, more flexible foils or foils which are less brittle can be formed.

According to an embodiment of the process of producing an electrode, the step of producing a slurry includes mixing the particles with a liquid and a binder. The liquid serves to disperse the particles. The binder provides adhesion between the particles prior to sintering. The binder may be one or more of the above-described binders.

According to a further embodiment of the process, a forming step can be performed on a sintered electrode. For example, the forming step can be applied after sintering in a two-step heating process, i.e. after the second heating step. The forming step can be a step of electrochemically oxidizing the electrode. For example, according to an embodiment, the voltage of the electrochemical oxidation, also called the forming voltage, can be between 200 V and 900 V, such as between 200 V and 700 V, for example. An oxide of 1 nm to 1.2 nm may be formed per Volt of forming voltage.

This may also correlate with an embodiment of the electrode which may apply to any other embodiment of the electrode disclosed herein. According to this present embodiment, a thickness of an oxide which is, for example, an above-mentioned oxide portion, can be smaller than 1.5 μm and, such as preferably 1.1 μm or smaller or, according to an embodiment, it may lie between 200 nm and 1100 nm, such as between 200 nm and 900 nm.

According to further embodiments explained in the following, the inventors found different ways of incorporating phosphorus into the particles or the oxide. These processes may be used as alternatives or used together to achieve a certain phosphorus content or phosphorus distribution in an oxide portion of an electrode.

According to a first embodiment which applies to the precursor material having the hydrated metal oxide as described above, or its process, the following embodiments apply. According to an embodiment of producing a precursor material, a phosphorus-containing compound can be added to the deionized water such that it comprises 3 ppm to 500 ppm of the phosphorus-containing compound or of a phosphate equivalent. A phosphorus-containing compound can be any compound that comprises phosphorus. For example, a phosphorus-containing compound may be ammonium phosphate. Alternatively or in addition, diammonium hydrogen phosphate, ammonium dihydrogen phosphate and/or phosphoric acid may be used. In particular diammonium hydrogen phosphate and ammonium dihydrogen phosphate can be advantageous. Also other phosphorus or phosphate phosphate-related compounds can be used. Here the term “phosphate equivalent in the water” can be understood in a similar manner to the term “phosphate equivalent in the oxide”. However here it may be regarded as the value or amount of phosphate that results or would result when all of the phosphorus present in the water were in the form of phosphate.

When boiling the particles for producing the precursor material in the phosphorus-compound-containing water, the phosphorus becomes incorporated into the developing hydrated metal oxide. The phosphorus can provide the above-described advantages.

According to another embodiment which can be an embodiment of the process of forming an electrode, phosphorus can also be incorporated into the oxide portion of the electrode that is formed electrochemically when the electrochemical oxidation is carried out. In this case the forming-electrolyte may comprise a phosphorus-containing compound. In this case, the phosphorus-containing compound can be ammonium phosphate, diammonium hydrogen phosphate, ammonium dihydrogen phosphate, for example. Also, phosphoric acid may be used, for example. Also, two or more the phosphorus-containing compounds can be used together. Diammonium hydrogen phosphate or ammonium dihydrogen phosphate have the advantage that in addition to being a source of phosphorus they can help to reduce the pH of the forming solution, without being too acidic. This phosphorus-containing compound may be present in a range of 1 to 3 ppm in the forming-electrolyte. This range is particularly preferable for ammonium phosphate, diammonium hydrogen phosphate and ammonium dihydrogen phosphate.

According to an embodiment that may be applied to increase the surface-near content of phosphorus as described for embodiments of the electrode above, the electrode can be boiled in ammonium phosphate containing water after sintering and after forming of the oxide. Alternative the water can contain diammonium hydrogen phosphate, ammonium dihydrogen phosphate or phosphoric acid, with of these diammonium hydrogen phosphate and ammonium dihydrogen phosphate being preferred. This leads to an incorporation into the surface-near region of the oxide that has already been formed. In particular, according to an embodiment by this the upper 5 to 10 nm can be enriched by a phosphorus-containing compound.

According to an embodiment of the process of producing a surface-near portion comprising phosphorus, a concentration of the phosphorus-containing compound can be 2 to 500 ppm.

As a further embodiment, a capacitive element is also described. The capacitive element comprises an electrode according to any of the embodiments discussed here. Furthermore, the capacitive element comprises a cathode. An electrolyte may be arranged between cathode and anode. For example, the electrolyte may be contained in a separator that is soaked with the electrolyte. In this case the separator is arranged between cathode and anode. For example, the capacitive element may be a winding element in which the anode and the cathode and optionally a separator are wound together.

Furthermore, a capacitor is described. The capacitor can be any capacitor comprising an electrode according to any of the embodiments discussed here as an anode. Most preferably, according to an embodiment, it is an electrolyte capacitor which comprises an above-described capacitive element.

In the following numbered embodiments of this disclosure are listed. These embodiments are numbered to simplify referencing between them. These embodiments or their features may also be combined with other embodiments or features described above or below.

1. Electrode having a sintered portion comprising or consisting of merged or sintered particles, wherein
the particles comprise a valve metal or a metal from the boron group, and
an average particle size of a size-distribution of the particles is below 6 μm.

2. Electrode according to embodiment 1, wherein the average particle size of the size-distribution of the particles is larger than 0.6 μm, such as preferably 1 μm or larger, or preferably 2 μm or larger.

3. Electrode having a sintered portion that is formed from a mixture of at least a first group of particles and a second group of particles which are merged or sintered, wherein
both the first and the second group of particles comprise a valve metal or a metal from the boron group, and
an average particle size of a size-distribution of the first group of particles is smaller than that of the second group of particles.

4. Electrode according to embodiment 3, wherein
the average particle size of the first group of particles is between 1 and 3 μm, and
the average particle size of the second group of particles is between 2.5 and 6 μm.

5. Electrode having a sintered portion comprising or consisting of merged or sintered particles, wherein
the particles comprise a valve metal or a metal from the boron group, and
the sintered portion and/or the particles comprise an oxide portion that is formed from composite particles that have a metallic portion and a portion comprising a hydrated metal oxide.

6. Electrode having a sintered portion comprising or consisting of merged or sintered particles, wherein
the particles comprise a valve metal or a metal from the boron group, and
the sintered portion and/or the particles comprise an oxide portion that comprises phosphorus.

7. Electrode according to embodiment 6, wherein the phosphorus is incorporated in the oxide material of the oxide portion.

8. Electrode according to embodiment 6 or embodiment 7, wherein a content of phosphorus as represented as phosphate-equivalent relative to the macroscopic area of the electrode surface in the entire oxide portion is 0.5 μmol·cm⁻² or higher or preferably 0.8 μmol·cm⁻² or higher.

9. Electrode according to any of embodiments 6 to 8, wherein a surface-near content of phosphorus in a surface near-region of the oxide portion is higher than in non-surface near portions of the oxide portion.

10. Electrode according to any of embodiments 6 to 9, wherein a surface-near content of phosphorus in a surface-near region of the oxide portion represented as phosphate-equivalent relative to the macroscopic area of the electrode surface is 10 mg·m⁻² or higher.

11. Electrode according to embodiment 10, wherein the surface-near region has a thickness of 5 to 10 nm.

12. Electrode according to embodiment 10 or embodiment 11, wherein the surface-near content of phosphorus is determinable by
cutting out a 5 cm×10 cm specimen of the electrode,
cutting the specimen into pieces of approximately 1 cm×1 cm,
placing the pieces into a 250 ml glass beaker,
filling 100 ml deionized water into the beaker,
boiling the pieces and the water in the beaker for 10 min,
cooling to room temperature,
refilling all of the boiled-off water back to a water volume of 100 ml by adding deionized water,
shaking and stirring the mixture,
measuring the phosphate concentration in the water in ppm, and
multiplying the value measured in ppm by 20 to get the value of the surface-near content of phosphorus in mg·m⁻².

13. Electrode according to any of the preceding embodiments, wherein the sintered portion is arranged on a surface of a substrate comprising or consisting of a first valve metal or a metal from the boron group.

14. Electrode according to any of the preceding embodiments, wherein the particles form a network of merged or sintered particles and/or the sintered portion is porous.

15. Electrode according to any of the preceding embodiments, wherein the sintered portion and/or the particles comprise an oxide portion that is formed at a forming voltage of at least 100 V.

16. Electrode according to embodiment 15, wherein the oxide portion is formed at a forming voltage of 200 V or above and 900 V or below.

17. Electrode according to embodiment 15 or embodiment 16, wherein the oxide portion has a thickness of 200 nm or above and/or 1.5 μm or below.

18. Precursor material for producing a sintered portion of an electrode comprising particles that comprise a valve metal or a metal from the boron group, wherein the particles have a hydrated metal oxide portion.

19. Precursor material according to embodiment 18, wherein the particles have a core-shell structure, in which a metallic core is at least partially surrounded by the hydrated metal oxide portion as the shell or part of the shell.

20. Precursor material according to embodiment 18 or embodiment 19, wherein the metal is aluminum, and the hydrated metal oxide is represented by Al₂O₃·xH₂O with 1≤x≤2.

21. Precursor material according to any of embodiments 18 to 20, wherein the thickness of the hydrated metal oxide portion is higher than 4 nm or preferably equal to or higher than 50 nm.

22. Process of producing a precursor material for producing a sintered portion of an electrode, including the steps of
providing metal particles comprising or consisting of a valve metal or a metal from the boron group,
providing deionized water that has a conductivity of 0.1 μS/cm at 30° C. or below 0.1 μS/cm at 30° C.,
boiling the metal particles in the water.

23. Process of producing a precursor material according to embodiment 22, wherein a content of silicon is smaller than 0.5 mg/l.

24. Process of producing a precursor material according to embodiment 22 or embodiment 23, wherein after providing the deionized water and prior to boiling the particles in the water, a phosphorus-containing compound is added to the deionized water such that the water comprises 3 ppm to 500 ppm of the phosphorus-containing compound or of a phosphate equivalent.

25. Process of producing a precursor material according to any of embodiments 22 to 24, wherein the particles are boiled in the water for 2 to 60 min, such as 2 to 30 min, for example.

26. Process of producing an electrode including,
making a slurry using the precursor material according to any of embodiments 18 to 21 or as produced according any of embodiments 22 to 25,
applying the slurry to a surface of a substrate comprising or consisting of a valve metal or a metal from the boron group,
heating the slurry at a first temperature and subsequently at a second temperature that is higher than the first temperature.

27. Process according to embodiment 26, wherein the first temperature is 300° C. or higher and 470° C. or lower.

28. Process according to embodiment 26 or embodiment 27, wherein the second temperature is below 560° C., or preferably 555° C. or below.

29. Process according to any of embodiments 26 to 28, wherein after the second heating step the electrode is electrochemically oxidized.

30. Process according to embodiment 29, wherein the forming voltage of the chemical oxidization is 200 V or higher and 900 V or lower.

31. Process according to embodiment 29 or embodiment 30, wherein the electrolyte for the electrochemical oxidation comprises 1 to 30 ppm of a phosphate compound.

32. Process according to any of embodiments 29 to 31, wherein the electrode is boiled in a solution comprising a phosphorus-containing compound.

33. Process according to embodiment 32, wherein the phosphorus-containing compound is ammonium phosphate, diammonium hydrogen phosphate, ammonium dihydrogen phosphate and/or phosphoric acid.

34. Process according to embodiment 32 or embodiment 33, wherein the concentration of the phosphorus-containing compound is 3 to 500 ppm mol/l.

35. Process according to any of embodiments 26 to 34, wherein producing a slurry includes mixing of the particles with a liquid in which to disperse the particles and a binder.

36. Capacitive element comprising a cathode and electrode as an anode according to any of embodiments 1 to 17.

37. Capacitor comprising a capacitive element according to embodiment 36.

### BRIEF DESCRIPTION OF THE DRAWINGS

Further embodiments of the electrode, the processes, the capacitive element, the capacitor and the precursor will become apparent from the following exemplary embodiments described in connection with the figures. However, please note that the invention is not limited to said exemplary embodiments. Further, said exemplary embodiments are at least partially depicted in figures showing schematic drawings. Such schematic drawings are not true to scale and absolute and relative dimensions can be depicted in a distorted manner. Rather, individual elements may be shown exaggeratedly large for better representability or better understandability. Accordingly, no absolute or relative dimensions can be taken from the schematic depictions unless otherwise indicated. Elements that are identical, similar or have the same effect or are configured to provide a similar effect are denoted by the same reference signs in the figures.

FIG. 1 shows an exemplary embodiment of a capacitor;

FIG. 2 shows a first exemplary embodiment of an electrode;

FIG. 3 shows an exemplary embodiment of a particle; and

FIG. 4 shows a second exemplary embodiment of an electrode.

### DETAILED DESCRIPTION OF ILLUSTRATIVE EMBODIMENTS

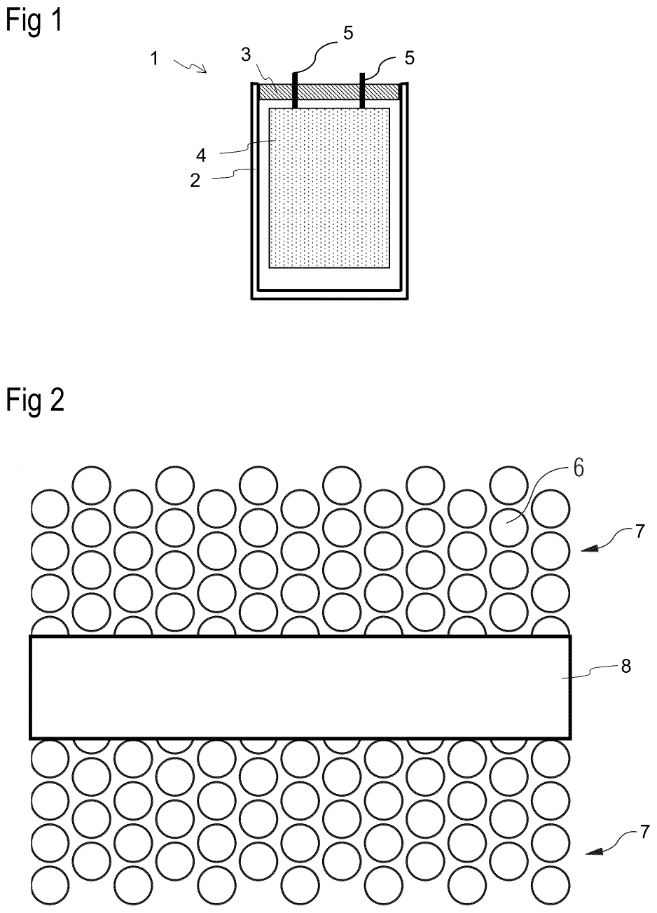

In FIG. 1 a capacitor 1 is shown in schematic cross-section. The capacitor has a casing 2 that is closed by a lid 3. A winding element 4 which is an example of a capacitive element is arranged inside the housing that is formed by the casing 2 and the lid 3. Though not explicitly depicted, the winding element 4 comprises a cathode and an anode which are separated by separator paper. The separator paper is soaked by an electrolyte. The cathode is not limited and can be any cathode. The anode is one of the anodes described in the following or any other anode that is disclosed herein. The anode and the cathode of the winding element 4 are each contacted by a lead-tab 5.

FIG. 2 shows a schematic cross-sectional depiction of a sintered electrode, which can be an anode. The electrode has a substrate 8 which comprises aluminum. Alternatively, it can comprise another metal from the boron group or another valve metal. The substrate is an aluminum foil that has a thickness of 5 to 50 μm. Alternatively, the foil can comprise another metal from the boron group or another valve metal. On both surfaces of the substrate 8, two sintered portions 7 are arranged which have a thickness of 40 to 130 μm. Each sintered portion 7 comprises merged or sintered particles 6. According to the present exemplary embodiment, the particles have a size of between 2 and 6 μm.

Not specifically apparent from the highly simplified representation in FIG. 2 is that in each sintered portion 7 the particles 6 are merged together by sintering, forming a network of particles 6. Some of the particles 6 are also sintered onto the substrate 8.

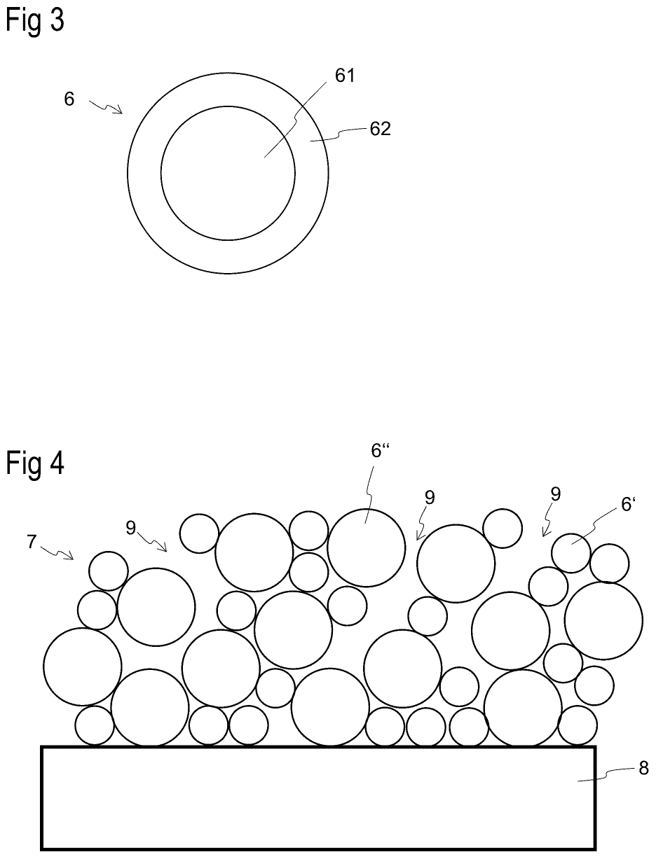

In FIG. 3, a core shell particle 6 is shown. This particle can, for example, be used for producing a sintered portion, similar to the one shown in FIG. 2 or in FIG. 4, which is discussed below, for example. The core shell particle 6 comprises an aluminum comprising core 61. The core 61 can consist of pure aluminum or an alloy including aluminum. Further, it comprises a thin hydrated aluminum oxide layer as shell 62. The hydrated metal oxide has boehmite or a pseudoboehmite structure. It is represented by the following formula: Al₂O₃·xH₂O with 1.0<x<2.0. Furthermore, the shell 62 of the core shell particle 6 has a thickness of 50 nm or above.

Please note that here the core shell particle 6 is represented by an idealized spherical shape. Of course, the industrially applied particles are not always idealized spherical particles. In the idealized spherical particles the thickness of the shell is measured as the thickness of a concentric spherical shell. For non-idealized particles the thickness is measured according to procedures known to the person ordinarily skilled in the art. For example, for a local point on the outer circumference of the core 61, a local tangential plane is applied. The thickness of the shell is measured perpendicular to said plane. In other terms, a local surface normal of the core provides the direction along which the thickness of the shell 62 can be measured.

According to a highly preferred variant of the present exemplary embodiment, the hydrated aluminum oxide shell comprises some phosphorus incorporated into the hydrated metal oxide.

The core shell particles can be produced by the following process. First of all, pure aluminum metal or aluminum alloy particles are provided. Furthermore, super pure deionized water with a conductivity of 0.1 μS/cm or below at 30° C. is provided. Furthermore, the silicon content of the super pure deionized water is below 0.5 mg/l. In this water, the particles are boiled for a time of 3 to 5 min, such as 4±0.5 min to reach a desired thickness of the hydrated metal oxide shell. In order to incorporate the phosphorus into the hydrated metal oxide shell 62, a phosphorus compound such as ammonium phosphate, diammonium hydrogen phosphate, ammonium dihydrogen phosphate and/or phosphoric acid is added in a range of 3 to 500 ppm to the previously super pure deionized water. Subsequently, the particles are boiled in this water. Thus, phosphorus can be incorporated into the hydrated oxide during the boiling process.

To form a sintered electrode, the hydrated metal oxide particles are mixed with a liquid such as a ketone or an alcohol to disperse the particles. An example for such a liquid can be a terpineol or a mixture of terpineols. Furthermore, a binder such as ethyl cellulose or alternatively PVDF or PVA is added. The resulting slurry is applied to a surface of a substrate 8, as shown above in FIG. 2. Subsequently, a two-step annealing process is applied. First, at a first temperature of between 300 to 470° C., the particles are slightly linked together and most of the hydrated metal oxide is transformed into a non-hydrated metal oxide of mainly gamma aluminum oxide structure. Subsequently, the particles are sintered at a temperature that is higher than the temperature chosen for the first step. The second temperature is, however, lower than 550° C. This overall process helps to keep a flexible or bendable structure of the electrode and reduce leakage. These low sintering temperatures also help to fix the particles on the surface such that they do not easily peel off from the surface when bending is applied. In the case of phosphorus incorporation, the leakage current can be even further reduced. Also, the phosphorus may improve resistivity against water hydration in a finished anode, which otherwise might be highly susceptible to gas formation even if only traces of water are present in the electrolyte of an electrolytic capacitor.

In particular, this core shell structure is not limited to, but can be applied to the particles as shown in FIG. 2 or the one as shown in FIG. 4.

In FIG. 4 a second exemplary embodiment of an electrode is shown. In principle, the construction is similar to that shown in FIG. 2. As depicted in this case only one side of the electrode has a sintered portion 7. However, the principles discussed here can also be applied to an electrode with two sintered portions.

First of all, as shown in FIG. 4, the sintered body 7 consists of two types of particles 6′ and 6″. The first type of particle 6′ is smaller than the second type of particle 6″. Both represent two size distributions of particles with different average sizes. The average size of the first group of particles with the reference number 6′ lies between 1 to 3 μm. The average of the size distribution of the second type of particles with the reference number 6″ lies between 2.5 and 6 μm. The inventors found that, by having different particle sizes, the advantages as explained above can be achieved. In particular, a precursor that comprises a mixture of particles can be more flexibly applied. On the other hand, the two different types of particles also provide a more stable sintered portion 7 than if only one size is used. Also, the idea of the network of particles in the sintered portion 7 is highlighted here more strongly than in the schematic representation of FIG. 2. In particular, pore-like openings 9 are also schematically indicated in this depiction.

The sintered portions 7 of the exemplary embodiments shown in FIGS. 2 and 4 can be formed by the process discussed with respect to the core-shell particle 6 discussed with respect to FIG. 3.

Furthermore, a forming step can be carried out to grow an insulating oxide on the sintered portion 7. A forming voltage of 200 V to 900 V can be used. Thereby an oxide of between 200 nm to 1100 nm can be formed.

In order to incorporate phosphate or additional phosphate into the formed oxide, 1 to 30 ppm of ammonium dihydrogen phosphate can be added to an electrolyte in which the electrochemical forming process is carried out. Thereby phosphorus is incorporated into the formed oxide.

Alternatively or in addition, after the forming process the electrode having a thick oxide can be boiled in water containing ammonium dihydrogen phosphate. Thereby phosphorus can be incorporated into the 5 to 10 nm of the oxide. This penetration depth of the phosphorus is a microscopic thickness of the complex oxide surface.

By all procedures using such phosphorus incorporation 0.8 μmol·cm⁻² or more of phosphate equivalent can be incorporated into the oxide on average. This amount of phosphorus is measured with respect to the macroscopic area of the electrode. The surface treatment described above can yield a surface phosphorus concentration of 10 mg·m⁻².

The total content of phosphorus is measured as follows: First of all, with the help of an accordingly sized punching tool, a cutout of an electrode having a sintered portion on two sides of a foil substrate is made. The punching tool produces two cuts one of 31.25×mm 80 mm and a further separate piece of 7 mm×60 mm. Together the pieces have a macroscopic surface area of 29.2 cm² per side of the electrode.

The punched out pieces are then weighted on analytical balance and the weight is recorded. The punched out pieces are cut via scissors to roughly square shapes with sides of roughly 1 to 3 mm. The minimum wight of the square should be above 0.123 g, preferably it should be around 0.2 g. The cut pieces are then weighted again and subsequently placed into a 100 ml Erlenmeyer flask. 15 ml of distilled water is added to the cut sample and 8 mm of concentrated sulfuric acid is added. After covering the flask, for example by a watch glass, it is boiled on a heating plate that has 200 to 250° C. The boiling is continued until the entire foil is completely dissolved and a transparent solution is achieved.

When the solution is clear, and after it is cooled to room temperature, it is put into a 100 ml measuring cup. The pouring is carried out such that the residue left in the flask is also washed through. After that, the solution in the measuring cup is partly neutralized with 30 ml of 2 mol sodium hydroxide. Subsequently the vessel is filled to the mark with distilled water.

Subsequently, the phosphate content can be determined by any suitable means. For example, a colorimetric method using a test kit from Hach Lange LCK349 or an equivalent test kit, for example provided by Merck, may be used.

Alternatively, a UV/Vis spectrometer can be used. Therefore, before measuring the sample, a blank sample is measured which is formed from 1 ml of distilled water mixed with 4 ml of a phosphate reagent. The phosphate reagent has the following composition for a 21 volume of the reagent prepared in a measuring flask: 6.12 g of tartaric acid, 17.7 g of ammonium heptamolybdate and 0.46 g of ammonium monovanadate are mixed with 1l of water. Subsequently 108 ml of concentrated (65%) nitric acid is added, then the measuring flask is filled up to 21 with distilled water.

The absorbance value of the blank sample is subtracted from the absorbance value of the sample. For the actual sample, the above-described 100 ml solution comprising the dissolved electrode is stirred well or shaken well. 1 ml of the sample is pipetted into the cuvette of the spectrometer. Subsequently 4 ml of the above-described phosphate reagent are added. Both components are mixed well, for example by shaking. Additionally, a 5 minute waiting time is applied. After that, the cuvette is inserted into the UV/Vis spectrometer and the absorbance is read. The measurement is carried out in manual mode at 410 nm wavelength. The measured value is set to absorbance. From these values the absolute amount of phosphate equivalent relative to the macroscopic surface area of the electrode can be calculated.

The surface-near content of phosphorus is measured in the following way. First of all, a sample of 5 cm×10 cm, i.e. of 50 cm² is cut out from the electrode. This specimen is then cut into pieces of approximately 1 cm² (1 cm×1 cm). These pieces are placed into a glass beaker of a volume of 250 ml. Furthermore, 100 ml of deionized water is filled into the glass beaker. The pieces are boiled in the water for 10 min. Subsequently, the mixture of the pieces in the water is cooled to room temperature. After that, any boiled-off water is replaced by refilling the water volume back to 100 ml by adding additional deionized water. The mixture is shaken and/or stirred. Subsequently, the phosphate concentration is measured in the water in ppm. This can, for example, be carried out by a UV/Vis approach as described below or by using a colorimetric method using a test kit from Hach Lange LCK349. The test kit provides a value measured in ppm. This value has to be multiplied by 20 to get the value of the surface-near content of phosphorus in mg/m².

What is claimed is:

1. An electrode comprising:
a sintered portion comprising or consisting of merged or sintered particles,
wherein the particles comprise a valve metal or a metal from the boron group, and
wherein the sintered portion and/or the particles comprise an oxide portion that comprises phosphorus.

2. The electrode according to claim 1, wherein the phosphorus is incorporated in an oxide material of the oxide portion.

3. The electrode according to claim 1, wherein a content of the phosphorus as represented as a phosphate equivalent relative to a macroscopic area of an electrode surface in an entire oxide portion is 0.5 μmol·cm⁻² or higher.

4. The electrode according to claim 1, wherein a surface-near content of the phosphorus in a surface-near region of the oxide portion is higher than in a non-surface-near portions of the oxide portion.

5. The electrode according to claim 1, wherein a surface-near content of the phosphorus in a surface-near region of the oxide portion represented as a phosphate equivalent relative to a macroscopic area of an electrode surface is 10 mg·m⁻² or higher.

6. The electrode according to claim 5, wherein the surface-near region has a thickness of 5 to 10 nm.

7. The electrode according to claim 6, wherein the surface-near content of the phosphorus is determinable by:
cutting out a 5 cm×10 cm specimen of the electrode,
cutting the specimen into pieces of approximately 1 cm×1 cm,
placing the pieces into a 250 ml glass beaker,
filling 100 ml deionized water into the beaker,
boiling the pieces and the water in the beaker for 10 min,
cooling to room temperature,
refilling boiled-off water back to a water volume of 100 ml by adding deionized water,
shaking and stirring the mixture,
measuring a phosphate concentration in the water in ppm, and
multiplying a value measured in ppm by 20 to get a value of the surface-near content of phosphorus in mg·m².

8. A capacitive element comprising:
a cathode; and
an anode,
wherein the anode is the electrode according to claim 1.

9. A capacitor comprising:
the capacitive element according to claim 8.

10. An electrode comprising:
a sintered portion comprising or consisting of merged or sintered particles,
wherein the particles comprise a valve metal or a metal from the boron group, and
wherein the sintered portion and/or the particles comprise an oxide portion that is formed from composite particles that have a metallic portion and a portion comprising a hydrated metal oxide.

11. The electrode according to claim 10,
wherein the sintered portion is formed from a mixture of at least a first group of particles and a second group of particles, which are merged or sintered,
wherein both the first and the second groups of particles comprise the valve metal or a metal from the boron group, and
wherein an average particle size of a size distribution of the first group of particles is smaller than that of the second group of particles.

12. The electrode according to claim 10, wherein the sintered portion is arranged on a surface of a substrate comprising or consisting of a first valve metal or a metal from the boron group.

13. A precursor material for producing a sintered portion of an electrode, the precursor material comprising:
particles comprising a valve metal or a metal from the boron group,
wherein the particles have a hydrated metal oxide portion.

14. The precursor material according to claim 13, wherein the particles have a core-shell structure, in which a metallic core is at least partially surrounded by the hydrated metal oxide portion as the shell or part of the shell.

15. The precursor material according to claim 13, wherein the metal is aluminum, and the hydrated metal oxide is represented by Al₂O₃·xH₂O with 1≤x≤2.

16. The precursor material according to claim 13, wherein a thickness of the hydrated metal oxide portion is higher than 4 nm.

17. A method for producing the electrode, the method comprising:
producing a slurry using the precursor material according to claim 13;
applying the slurry to a surface of a substrate comprising or consisting of the valve metal or a metal from the boron group; and
heating the slurry at a first temperature and subsequently at a second temperature that is higher than the first temperature.

18. The method according to claim 17, wherein the first temperature is 300° C. or higher and 470° C. or lower.

19. The method according to claim 17, wherein the second temperature is below 560° C.

20. The method according to claim 17, further comprising, after heating at the second temperature, electrochemically oxidizing the electrode.

21. The method according to claim 20, wherein an electrolyte for an electrochemical oxidation comprises 1 ppm to 30 ppm of a phosphate compound.

22. The method according to claim 20, wherein the electrode is boiled in a solution comprising a phosphorus-containing compound.

23. The method according to claim 22, wherein the phosphorus-containing compound is ammonium phosphate, diammonium hydrogen phosphate, ammonium dihydrogen phosphate and/or phosphoric acid.

24. The method according to claim 22, wherein a concentration of the phosphorus-containing compound is 3 ppm mol/L to 500 ppm mol/l.

25. The method according to claim 17, wherein a forming voltage for a chemical oxidization is 200 V or higher and 900 V or lower.

26. The method according to claim 17, wherein producing the slurry comprises mixing the particles with a liquid in which the particles and a binder are dispensed.

27. A method for producing a precursor material for producing a sintered portion of an electrode, the method comprising:
providing metal particles comprising or consisting of a valve metal or a metal from the boron group;
providing deionized water that has a conductivity of 0.1 μS/cm at 30° C. or below 0.1 μS/cm at 30° C.; and
boiling the metal particles in the water.

28. The method according to claim 27, wherein a content of silicon is smaller than 0.5 mg/l.

29. The method according to claim 27, further comprising, after providing the deionized water and prior to boiling the particles in the water, adding a phosphorus-containing compound to the deionized water such that the water comprises 3 ppm to 500 ppm of the phosphorus-containing compound or of a phosphate equivalent.

30. The method according to claim 27, wherein the particles are boiled in the water for 2 min to 60 min.
